(19) United States
(12) Patent Application Publication
(10) Pub. No.: US 2022/0332484 A1
(43) Pub. Date: Oct. 20, 2022

(54) A SHRINK LABEL AND METHOD OF USE

(71) Applicant: Fuji Seal International, Inc., Osaka (JP)

(72) Inventor: Billy Brady, Bardstown, KY (US)

(21) Appl. No.: 17/760,929

(22) PCT Filed: Sep. 24, 2020
(86) PCT No.: PCT/IB2020/000787

§ 371 Date: Mar. 16, 2022

Related U.S. Application Data
(60) Provisional application No. 62/905,597, filed on Sep. 25, 2019.

(51) Int. Cl. B65D 55/08; B65D 51/18; B65C 3/20; G09F 3/00; G09F 3/03; G09F 3/10

(52) U.S. Cl. CPC B65D 55/0854; B65D 51/18; B65C 3/20; G09F 3/0291; G09F 3/0341; G09F 3/10; B65D 2251/0031; B65D 2251/0078; G09F 2003/023

(57) ABSTRACT

A shrink label for application to a bottle and a cap is provided to maintain the position of the cap relative to the bottle. The shrink label includes an interior surface defining an opening therethrough, a first adhesive strip extending circumferentially about the interior surface of the shrink label, and a second adhesive strip spaced a distance above the first adhesive strip and extending circumferentially about the interior surface of the shrink label. The first adhesive strip is aligned with a portion of the bottle and the second adhesive strip is aligned with a side portion of the cap such that an intersection point between the bottle and the cap is positioned between the first adhesive strip and the second adhesive strip. A perforation line can be included on the shrink label above the second adhesive strip for removal of the shrink label.

### PRIORITY

This application claims priority to U.S. Provisional Application No. 62/905,597, entitled “Cap Seal,” filed on Sep. 25, 2019, the disclosure of which is incorporated by reference herein.

### TECHNICAL FIELD

The disclosed embodiments generally pertain to shrink labels.

### BACKGROUND

Containers, such as bottles, typically have a body that is configured to hold a product, such as a liquid, within an interior space of the body. The bottle may then have an opening to dispense product through the opening and a cap selectively coupled with the body for covering the opening of the bottle. A shrink label can be applied about the bottle and/or cap in order to display product names or the like, achieve decorative effects, and/or provide a tamper-proof covering. In some instances, the cap may loosen from the bottle during shipping or transportation of the bottle, which may allow product to leak from the bottle. It may therefore be desirable to provide a shrink label that is configured to inhibit leaking during shipping or transportation.

While a variety of shrink labels have been made and used, it is believed that no one prior to the inventors has made or used an invention as described herein.

### BRIEF DESCRIPTION OF THE DRAWINGS

It is believed the present invention will be better understood from the following description of certain examples taken in conjunction with the accompanying drawings, in which like reference numerals identify the same elements.

FIG. 1 depicts a perspective view of an exemplary shrink label applied to a bottle and a cap.

FIG. 2 depicts a front elevational view of the shrink label of FIG. 1 in an open configuration.

FIG. 3 depicts a perspective view of the shrink label of FIG. 1 in a closed configuration.

FIG. 4A depicts a perspective view of the shrink label of FIG. 1 in a closed configuration being positioned onto the bottle and the cap.

FIG. 4B depicts a perspective view of the shrink label of FIG. 4A fully positioned onto the bottle and the cap.

FIG. 4C depicts a perspective view of the shrink label of FIG. 4B in a sealed configuration.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

For clarity of disclosure, spatial terms such as “lower,” “upper,” “vertically,” “horizontally,” “top,” “bottom,” “central,” “side,” “interior,” and “exterior” are used herein for reference to relative positions and directions. Such terms are used below with reference to views as illustrated for clarity and are not intended to limit the innovation described herein.

The word “exemplary” is used herein to mean “serving as an example, instance, or illustration.” Any implementation described herein as “exemplary” is not necessarily to be construed as preferred or advantageous over other implementations.

In some instances, there is a desire for a shrink label that is configured to inhibit product from leaking from the bottle during shipping or transportation. Accordingly, an exemplary shrink label is provided that is applied to at least a portion of the cap and at least a portion of the bottle. The shrink label includes a first adhesive strip positioned about the cap and a second adhesive strip positioned about the bottle to sufficiently secure the cap relative to the bottle and inhibit the cap from loosening relative to the bottle such as during transportation. The shrink label is also coupled with the bottle and the cap such that an intersection point between the bottle and the cap is positioned between the first adhesive strip and the second adhesive strip such that the shrink label is sufficient sealed with the bottle and the cap to contain any incidentally leaked product between the first and second adhesive strips. In some versions, the shrink label includes a perforation line to aid in the removal of the shrink label from the bottle.

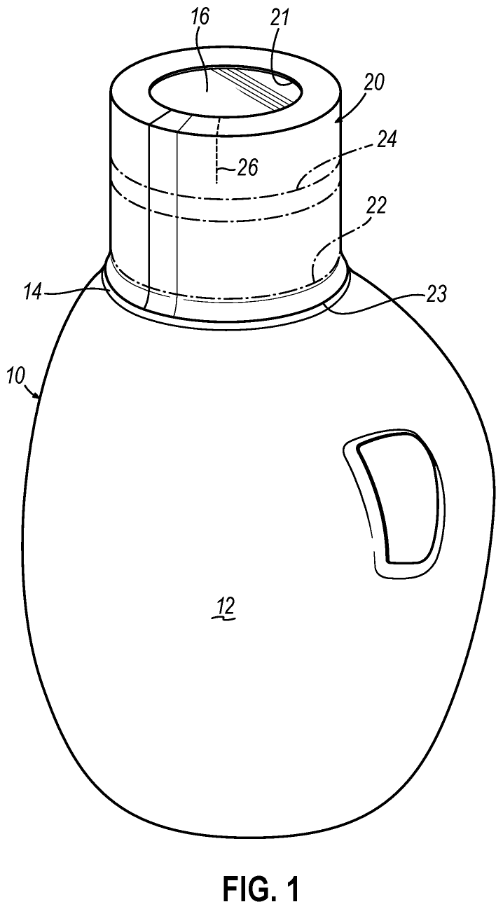

Referring to FIG. 1, an exemplary shrink label (20) is shown attached to a container (10) and a cap (16). In the illustrated version, container (10) is in the form of a bottle, though any other suitable container having a cap can be used (e.g., a jug, a carton, a can, a jar, etc.). As shown in FIG. 1, bottle (10) includes a body (12) defining an interior space for storing product, such as a liquid. A top end portion of body (12) includes a neck (14) having an opening (not shown) to provide access to the product within body (12). Neck (14) is threadably coupled with cap (16) such that cap (16) selectively closes the opening of bottle (10) to inhibit product from being dispensed from bottle (10). In some other versions, cap (16) is coupled with bottle (10) using other suitable configurations, such as a snap fit, a friction fit, a living hinge, etc. Still other suitable configurations for bottle (10) and cap (16) will be apparent to one with ordinary skill in the art in view of the teachings herein.

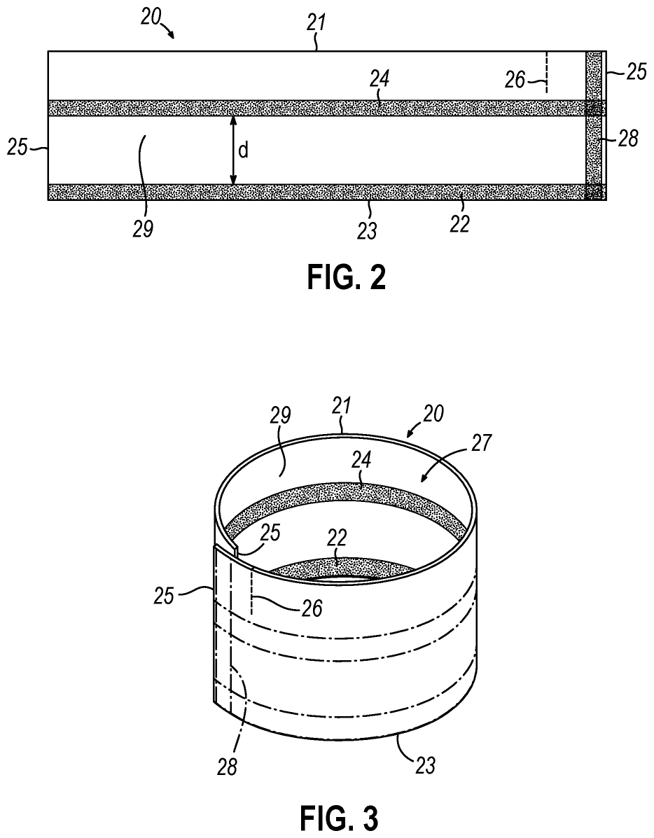

Shrink label (20) is shown in more detail in FIGS. 2-3. Referring to FIG. 2, shrink label (20) is shown in a flat or open configuration having a top surface (21), a bottom surface (23), and a pair of opposing end portions (25) extending between top and bottom surfaces (21, 23). Shrink label (20) further comprises a coupling (28) extending generally vertically along a portion of a width of shrink label (20) at or near at least one end portion (25). Coupling (28) includes a solvent welding that is configured to secure one end (25) of shrink label (20) with the other end (25) of shrink label (20). Accordingly, shrink label (20) is configured to wrap into a closed configuration, as shown in FIG. 3, by overlapping end portions (25) with each other to form a substantially cylindrical shape that defines an opening (27) extending therethrough. Such a substantially cylindrical shape may include a shrink label (20) that is slightly tapered inwardly and/or outwardly such that top surface (21) has a larger diameter than bottom surface (23) or top surface (21) has a smaller diameter than bottom surface (23) in the closed configuration. Coupling (28) sufficiently secures end portions (25) together to maintain the position of end portions (25) relative to each other to hold shrink label (20) in the closed position. Shrink label (20), in the closed configuration, is thereby configured to receive at least a portion of bottle (10) and cap (16) within opening (27). Shrink label (20) may comprise any suitable plastic material and/or film that is configured to shrink and thereby form to at least a portion of bottle (10) and cap (16) when heated.

As shown in FIGS. 2-3, shrink label (20) comprises a lower adhesive strip (22) positioned along a bottom portion of an interior surface (29) of shrink label (20). In the illustrated version, lower adhesive strip (22) is positioned along bottom surface (23) of shrink label (20). In some other versions, lower adhesive strip (22) is positioned above bottom surface (23) of shrink label (20). Lower adhesive strip (22) extends substantially continuously and horizontally along a length of shrink label (20) such that in the closed configuration lower adhesive strip (22) extends substantially about a circumference of an interior surface of shrink label (20). Lower adhesive strip (22) may be printed on interior surface (29) of shrink label (20) and can be solvent and/or water based. Lower adhesive strip (22) is configured to adhere to at least a portion of bottle (10) to maintain the position of shrink label (20) relative to bottle (10) when shrink label (20) is heated. Lower adhesive strip (22) may also be sufficiently sealed with bottle (10) to contain any incidental leaks from bottle (10). Lower adhesive strip (22) is configured to be easily removed from bottle (10) when shrink label (20) is removed from bottle (10). Still other suitable configurations for lower adhesive strip (22) will be apparent to one with ordinary skill in the art in view of the teachings herein. For instance, lower adhesive strip (22) may additionally or alternatively include a hot melt material.

Shrink label (20) further comprises an upper adhesive strip (24) spaced a distance (d) above lower adhesive strip (22) of shrink label (20). Accordingly, upper adhesive strip (24) is spaced from lower adhesive strip (22) to provide a non-adhesive portion on interior surface (29) of shrink label (20) between distance (d). In the illustrated version, upper adhesive strip (24) is positioned along a central portion of interior surface (29) of shrink label (20), below top surface (21). In some other versions, upper adhesive strip (24) is positioned adjacent to top surface (21). Upper adhesive strip (24) extends substantially continuously and horizontally along a length of shrink label (20) such that in the closed configuration upper adhesive strip (24) extends substantially about a circumference of an interior surface of shrink label (20). Upper adhesive strip (22) may be printed on interior surface (29) of shrink label (20) and can be solvent and/or water based. Upper adhesive strip (24) is configured to adhere to at least a portion of cap (16) to maintain the position of shrink label (20) relative to cap (16) when shrink label (20) is heated. Upper adhesive strip (24) is also sufficiently sealed with cap (16) to contain any incidental leaks. Upper adhesive strip (24) is configured to be easily removed from cap (16) when shrink label (20) is removed from bottle (10). Still other suitable configurations for upper adhesive strip (24) will be apparent to one with ordinary skill in the art in view of the teachings herein. For instance, upper adhesive strip (24) may additionally or alternatively include a hot melt material.

Shrink label (20) can further comprise one or more perforation lines (26) extending generally vertically from top surface (21) of shrink label (20) to upper adhesive strip (24). In the illustrated version, perforation line (26) does not extend below upper adhesive strip (24) such that perforation line (26) is configured to not interfere with the seal of upper and/or lower adhesive strips (22, 24). Perforation line (26) is breakable along perforation line (26) such that perforation line (26) is configured to tear easily to aid in the removal of shrink label (20) from bottle (10). Perforation line (26) thereby allows a user to grasp an upper portion of shrink label (20) at or near top surface (21) and pull downward to tear shrink label (20) along perforation line (26) and remove shrink label (20) from bottle (10).

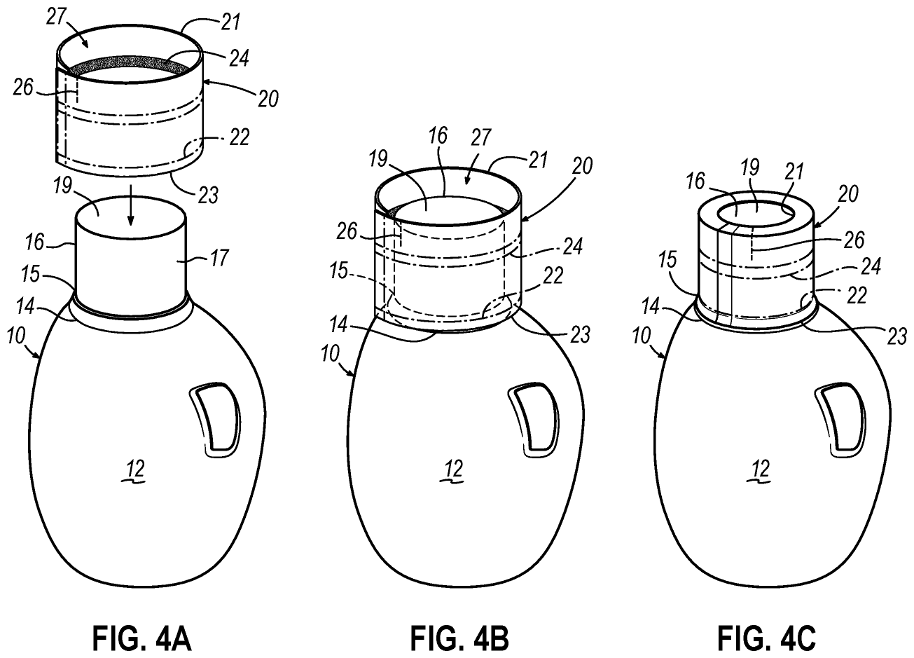

Referring to FIG. 4A, shrink label (20), in the closed configuration, can be applied to bottle (10) and cap (16) by positioning shrink label (20) about bottle (10) and cap (26) to insert bottle (10) and cap (16) through opening (27) of shrink label (20) and within interior surface (29) of shrink label (20). Referring to FIG. 4B, shrink label (20) can thereby be positioned to align lower adhesive strip (22) about a portion of body (12) and/or neck (14) of bottle (10) and upper adhesive strip (24) about a side portion (17) of cap (16). Top surface (21) of shrink label (20) may extend above cap (16). Heat may then be applied to shrink label (20) such that shrink label (20) shrinks to form to a portion of bottle (10) and cap (16), as shown in FIG. 4C. For instance, shrink label (20) may be heated to a temperature from about 90° C. to about 120° C. in a steam tunnel for about 6 seconds to about 8 seconds. Alternatively, shrink label (20) may be heated to a temperature from about 140° C. to about 160° C. in a hot air tunnel for about 4 seconds to about 6 seconds. As shrink label (20) is heated to form to a portion of bottle (10) and cap (16), lower adhesive strip (22) is adhered to a portion of body (12) and/or neck (14) of bottle (10) and upper adhesive strip (24) is adhered to side portion (17) of cap (16). In some versions, lower and/or upper adhesive strips (22, 24) may be positioned about bottle (10) and/or cap (16), instead of shrink label (20), and then adhered to shrink label (20). By adhering upper adhesive strip (24) to side portion (17) of cap (16), upper adhesive strip (24) may provide a better seal than if upper adhesive strip (24) were adhered to a top portion (19) of cap (16). In the illustrated version, shrink label (20) extends above side portion (17) of cap (16) to top portion (19) of cap (16) such that top surface (21) of shrink label (20) is positioned on top portion (19) of cap (16) in the closed and sealed configuration shown in FIG. 4C. In some other versions, shrink label (20) may not extend to top portion (19) of cap (16) such that shrink label (20) only extends along side portion (17) of cap (16).

Accordingly, upper adhesive strip (24) is adhered to cap (16) and lower adhesive strip (22) is adhered to bottle (10) such that an intersection point (15) between bottle (10) and cap (16) is positioned within the space between lower and upper adhesive strips (22, 24). Shrink label (20) thereby holds the position of the cap (16) relative to the bottle (10) to further secure the cap (16) with the bottle (10). This inhibits the cap (16) from rotating and/or loosening relative to the bottle (10) to prevent product from leaking from the bottle (10). If any incidental leaks do occur between bottle (10) and cap (16), adhesive strips (22, 24) may also contain such leaks from bottle (10) between adhesive strips (22, 24). In some versions, labels, product names, and/or other decorative features may be printed on an exterior surface of shrink label (20).

To remove shrink label (20) from bottle (10), a user may grasp shrink label (20) at or near top surface (21), such as adjacent to perforation line (26), and then pull downward on an upper portion of shrink label (20) to tear shrink label (20) along perforation line (26) down to upper adhesive strip (24). Shrink label (20) can then be ripped along perforation line (26) to remove shrink label (20) from bottle (10). Adhesive strips (22, 24) are thereby detached from bottle (10) and cap (16) as shrink label (20) is removed. Cap (16) is then exposed to allow a user to remove cap (16) and dispense product from the bottle (10). Still other suitable configurations and methods for shrink label (20) will be apparent to one with ordinary skill in the art in view of the teachings herein. For instance, in some versions, shrink label (20) may comprise a pull-tab to aid in removing a portion of the shrink label (20).

### EXAMPLES

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A shrink label comprising: an interior surface defining an opening therethrough; a first adhesive strip extending circumferentially about the interior surface of the shrink label, wherein the first adhesive strip is configured to adhere to a portion of a container; and a second adhesive strip spaced a distance above the first adhesive strip, wherein the second adhesive strip extends circumferentially about the interior surface of the shrink label, wherein the second adhesive strip is configured to adhere to a side portion of a cap; wherein the distance between the first adhesive strip and the second adhesive strip of the shrink label is sufficiently sized to receive an intersection point of the container and the cap within the distance between the first adhesive strip and the second adhesive strip, wherein the shrink label is configured to maintain the position of the cap relative to the container.

### Example 2

The shrink label of example 1, wherein the shrink label comprises a pair of opposing end portions that are overlapped with each other to form a generally cylindrical shape.

### Example 3

The shrink label of example 2, wherein the shrink label comprises a coupling extending generally vertically along at least one end portion of the pair of opposing end portions such that the coupling is positioned between the pair of opposing end portions to maintain the position of the pair of opposing end portions relative to each other.

### Example 4

The shrink label of any of examples 1 through 3, wherein the first adhesive strip is positioned adjacent to a bottom surface of the shrink label.

### Example 5

The shrink label of any of examples 1 through 4, wherein the second adhesive strip is positioned within a central portion of the shrink label between a top surface and a bottom surface of the shrink label.

### Example 6

The shrink label of any of examples 1 through 5, wherein the first and second adhesive strips comprise a select one or both of a solvent and water-based adhesive.

### Example 7

The shrink label of any of examples 1 through 6, wherein the first adhesive strip is configured to adhere to the portion of the container when the shrink label is heated, and wherein the second adhesive strip is configured to adhere to the side portion of the cap when the shrink label is heated.

### Example 8

The shrink label of any of examples 1 through 7, wherein the shrink label comprises a perforation line extending generally vertically along the shrink label, wherein a top edge of the perforation line is positioned at a top surface of the shrink label, and wherein a bottom edge of the perforation line is positioned above the second adhesive strip, wherein the shrink label is breakable along the perforation line.

### Example 9

The shrink label of any of examples 1 through 8, wherein the first and second adhesive strips are sufficiently sealed with the respective container and cap such that the first and second adhesive strips are configured to contain a product leaked from the container between the first and second adhesive strips.

### Example 10

A container comprising a body, a cap selectively coupleable with the body, and a shrink label attached to the container, wherein the shrink label comprises: an interior surface defining an opening therethrough; a first adhesive strip extending circumferentially about the interior surface of the shrink label, wherein the first adhesive strip is adhered to a portion of the body of the container; and a second adhesive strip spaced a distance above the first adhesive strip, wherein the second adhesive strip extends circumferentially about the interior surface of the shrink label, wherein the second adhesive strip is adhered to a side portion of the cap; wherein the distance between the first adhesive strip and the second adhesive strip of the shrink label is sufficiently sized to receive an intersection point of the body and the cap within the distance between the first adhesive strip and the second adhesive strip, wherein the shrink label is configured to maintain the position of the cap relative to the body.

### Example 11

A method of applying a shrink label to a container and a cap, wherein the shrink label comprises an interior surface defining an opening therethrough, a first adhesive strip extending circumferentially about the interior surface of the shrink label, and a second adhesive strip spaced a distance above the first adhesive strip, wherein the second adhesive strip extends circumferentially about the interior surface of the shrink label, the method comprising the steps of: positioning the container and the cap within the opening of the shrink label to align the first adhesive strip with a portion of the container and the second adhesive strip with a side portion of the cap; applying heat to the shrink label to form the shrink label to the portion of the container and the side portion of the cap; and adhering the first adhesive strip to the portion of the container and the second adhesive strip to the side portion of the cap.

### Example 12

The method of example 11, wherein a top surface of the shrink label is positioned on a top portion of the cap.

### Example 13

The method of any of examples 11 through 12, wherein an intersection point between the portion of the container and the side portion of the cap is positioned within a space between the first and second adhesive strips.

### Example 14

The method of any of examples 11 through 13, wherein the shrink label is coupled with the container and the cap to maintain the position of the cap relative to the container.

### Example 15

The method of any of examples 11 through 14, wherein the first and second adhesive strips are sufficiently sealed with the respective portions of the cap and the container to inhibit a product stored within the container from leaking through the first and second adhesive strips.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

1. A shrink label comprising:
an interior surface defining an opening therethrough;
a first adhesive strip extending circumferentially about the interior surface of the shrink label, wherein the first adhesive strip is configured to adhere to a portion of a container; and
a second adhesive strip spaced a distance above the first adhesive strip, wherein the second adhesive strip extends circumferentially about the interior surface of the shrink label, wherein the second adhesive strip is configured to adhere to a side portion of a cap;
wherein the distance between the first adhesive strip and the second adhesive strip of the shrink label is sufficiently sized to receive an intersection point of the container and the cap within the distance between the first adhesive strip and the second adhesive strip, wherein the shrink label is configured to maintain the position of the cap relative to the container.

2. The shrink label of claim 1, wherein the shrink label comprises a pair of opposing end portions that are overlapped with each other to form a generally cylindrical shape.

3. The shrink label of claim 2, wherein the shrink label comprises a coupling extending generally vertically along at least one end portion of the pair of opposing end portions such that the coupling is positioned between the pair of opposing end portions to maintain the position of the pair of opposing end portions relative to each other.

4. The shrink label of claim 1, wherein the first adhesive strip is positioned adjacent to a bottom surface of the shrink label.

5. The shrink label of claim 1, wherein the second adhesive strip is positioned within a central portion of the shrink label between a top surface and the first adhesive strip of the shrink label.

6. The shrink label of claim 1, wherein the first and second adhesive strips comprise a select one or both of a solvent and water-based adhesive.

7. The shrink label of claim 1, wherein the first adhesive strip is configured to adhere to the portion of the container when the shrink label is heated, and wherein the second adhesive strip is configured to adhere to the side portion of the cap when the shrink label is heated.

8. The shrink label of claim 1, wherein the shrink label comprises a perforation line extending generally vertically along the shrink label, wherein a top edge of the perforation line is positioned at a top surface of the shrink label, and wherein a bottom edge of the perforation line is positioned above the second adhesive strip, wherein the shrink label is breakable along the perforation line.

9. The shrink label of claim 1, wherein the first and second adhesive strips are sufficiently sealed with the respective container and cap such that the first and second adhesive strips are configured to contain a product leaked from the container between the first and second adhesive strips.

10. A container comprising a body, a cap selectively coupleable with the body, and a shrink label attached to the container, wherein the shrink label comprises:
an interior surface defining an opening therethrough;
a first adhesive strip extending circumferentially about the interior surface of the shrink label, wherein the first adhesive strip is adhered to a portion of the body of the container; and
a second adhesive strip spaced a distance above the first adhesive strip, wherein the second adhesive strip extends circumferentially about the interior surface of the shrink label, wherein the second adhesive strip is adhered to a side portion of the cap;
wherein the distance between the first adhesive strip and the second adhesive strip of the shrink label is sufficiently sized to receive an intersection point of the body and the cap within the distance between the first adhesive strip and the second adhesive strip, wherein the shrink label is configured to maintain the position of the cap relative to the body.

11. A method of applying a shrink label to a container and a cap, wherein the shrink label comprises an interior surface defining an opening therethrough, a first adhesive strip extending circumferentially about the interior surface of the shrink label, and a second adhesive strip spaced a distance above the first adhesive strip, wherein the second adhesive strip extends circumferentially about the interior surface of the shrink label, the method comprising the steps of:
positioning the container and the cap within the opening of the shrink label to align the first adhesive strip with a portion of the container and the second adhesive strip with a side portion of the cap;
applying heat to the shrink label to form the shrink label to the portion of the container and the side portion of the cap; and
adhering the first adhesive strip to the portion of the container and the second adhesive strip to the side portion of the cap.

12. The method of claim 11, wherein a top surface of the shrink label is positioned on a top portion of the cap.

13. The method of claim 11, wherein an intersection point between the portion of the container and the side portion of the cap is positioned within a space between the first and second adhesive strips.

14. The method of claim 11, wherein the shrink label is coupled with the container and the cap to maintain the position of the cap relative to the container.

15. The method of claim 11, wherein the first and second adhesive strips are sufficiently sealed with the respective portions of the cap and the container to inhibit a product stored within the container from leaking through the first and second adhesive strips.
